(19) United States
(12) Patent Application Publication
(10) Pub. No.: US 2024/0004227 A1
(43) Pub. Date: Jan. 4, 2024

(54) INSULATED GLAZING UNIT COMISSIONING ELECTRONICS PACKAGE

(71) Applicant: SAGE ELECTROCHROMICS, INC., Faribault, MN (US)

(72) Inventors: Bryan D. GREER, Northfield, MN (US); Philip SPANDE, Lakeville, MN (US)

(21) Appl. No.: 18/340,629

(22) Filed: Jun. 23, 2023

Related U.S. Application Data
(60) Provisional application No. 63/357,381, filed on Jun. 30, 2022.
(60) Provisional application No. 63/371,954, filed on Aug. 19, 2022.

(51) Int. Cl. G02F 1/13; G02F 1/1514

(52) U.S. Cl. CPC G02F 1/1309; G02F 1/1514

(57) ABSTRACT

A method of testing one or more electrochromic devices and/or wiring during commissioning is disclosed. The method can include providing one or more electrochromic devices and at least one controller. The controller can be electrically connected to the one or more electrochromic devices. The method can further include setting a commissioning voltage for the one or more electrochromic devices. The commissioning voltage can be no more than 2 V. The method can further include sending from the at least one controller, the commissioning voltage to each of the one or more electrochromic devices to change the one or more electrochromic devices from a first transmission state to a second transmission state.

### CROSS-REFERENCE TO RELATED APPLICATION(S)

This application claims priority under 35 U.S.C. § 119(e) to U.S. Provisional Application No. 63/357,381, entitled “INSULATED GLAZING UNIT COMMISSIONING ELECTRONICS PACKAGE,” by Bryan D. GREER et al., filed Jun. 30, 2022, and this application claims priority under 35 U.S.C. § 119(e) to U.S. Provisional Application No. 63/371,954, entitled “INSULATED GLAZING UNIT COMMISSIONING ELECTRONICS PACKAGE,” by Bryan D. GREER et al., filed Aug. 19, 2022, which are both assigned to the current assignee hereof and incorporated herein by reference in their entireties.

### FIELD OF THE DISCLOSURE

The present disclosure is directed to insulated glazing units that contain electrochromic devices, and more specifically to insulated glazing units and the control modules used in conjunction with the electrochromic devices.

### BACKGROUND

An electrochromic device can include an electrochromic stack where transparent conductive layers are used to provide electrical connections for the operation of the stack. Electrochromic (EC) devices employ materials capable of reversibly altering their optical properties following electrochromic oxidation and reduction in response to an applied potential. The optical modulation is the result of the simultaneous insertion and extraction of electrons and charge compensating ions in the electrochromic material lattice.

EC devices have a composite structure through which the transmittance of light can be modulated. A typical layer solid-state electrochromic device in cross-section has the following superimposed layers: a first transparent conductive layer which serves to apply an electrical potential to the electrochromic device, an electrochromic electrode layer which produces a change in absorption or reflection upon oxidation or reduction, an electrolyte layer that allows the passage of ions while blocking electronic current, a counter electrode layer which serves as a storage layer for ions when the device is in the bleached or clear state, and a second transparent conductive layer which also serves to apply an electrical potential to the electrochromic device. EC devices can then be incorporated with various other elements, including a control module which is connected to the electrochromic device by wires that run within the frame or supporting unit. The insulated glazing unit can then be installed within the frame of a window where the wires are out of view.

However, further improvements of insulated glazing units and window designs are desired.

### BRIEF DESCRIPTION OF THE DRAWINGS

Embodiments are illustrated by way of example and are not limited in the accompanying figures.

FIG. 1 is a schematic illustration of an insulated glazing unit, according to the embodiment of the current disclosure.

FIG. 2 illustrates a cross-section view of an electrochromic device on a substrate, according to one embodiment.

FIG. 3 shows an illustration of an electronics module and an electrochromic device, according to one embodiment.

FIG. 4 shows a method of testing one or more electrochromic devices during commissioning, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of the embodiments of the invention.

### DETAILED DESCRIPTION

The following description in combination with the figures is provided to assist in understanding the teachings disclosed herein. The following discussion will focus on specific embodiments and implementations of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or.

The use of “over” is employed to describe elements and components described herein. This description includes variations meant to include layers which are or are not in direct contact with the others.

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

In an embodiment, an electrochromic device can include a substrate, a first transparent conductive layer over the substrate, a second transparent conductive layer over the substrate, an electrochromic layer, and a counter electrode layer between the first transparent conductive layer and the second transparent conductive layer, and a control device to control a transmission state of the electrochromic device.

In another embodiment, a method of testing one or more electrochromic devices during commissioning can include providing one or more electrochromic devices, and at least one controller, where the controller is electrically connected to the one or more electrochromic devices; setting a commissioning voltage for the one or more electrochromic devices, where the commissioning universally safe voltage or a voltage known to be safe for all product sizes and configurations; and sending the commissioning voltage to each of the one or more electrochromic devices to change the one or more electrochromic devices from a first transmission state to a second transmission state, where the at least one controller sends the commissioning voltage.

The embodiments as illustrated in the figures and described below help in understanding particular applications for implementing the concepts as described herein. The embodiments are exemplary and not intended to limit the scope of the appended claims.

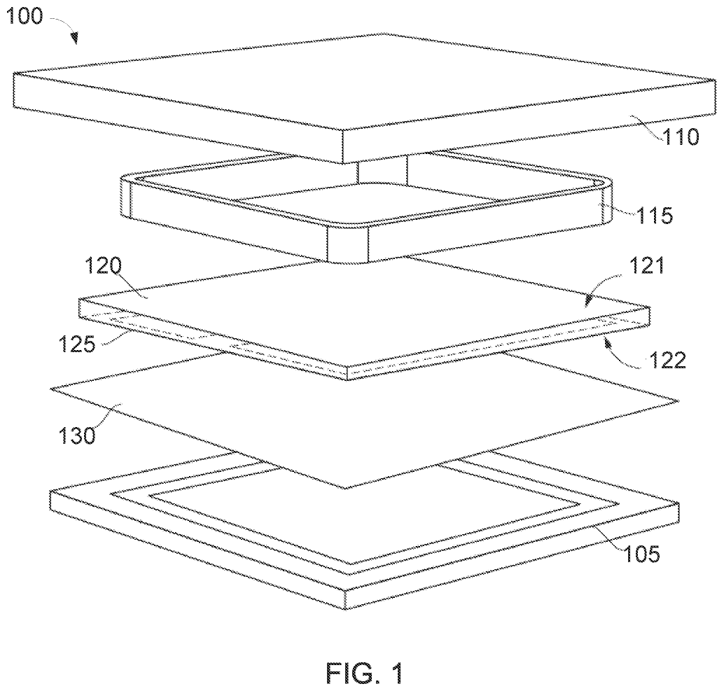

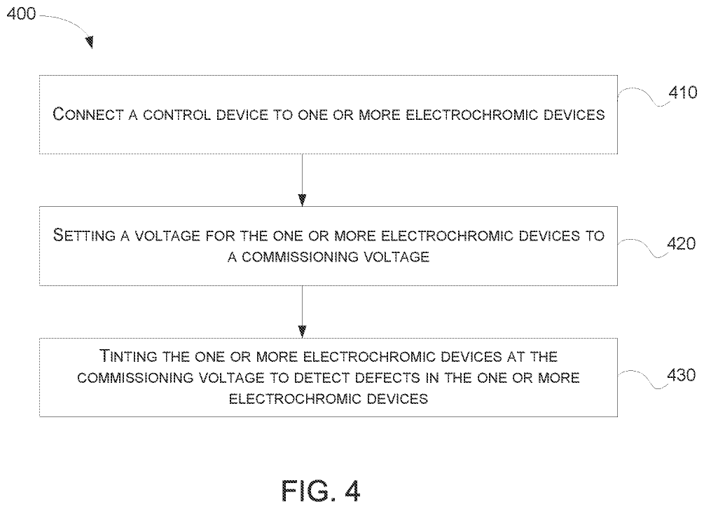

FIG. 1 is a schematic illustration of an insulated glazing unit 100 according to the embodiment of the current disclosure. The insulated glazing unit 100 can include a first panel 105, an electrochromic device 120 coupled to the first panel 105, a second panel 110, and a spacer 115 between the first panel 105 and second panel 110. As will be discussed below with respect to FIG. 4, the insulated glazing unit 100 can also include an electronics module with a controller to test the electrochromic devices for any defects during commissioning. The first panel 105 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 105 may or may not be flexible. In a particular embodiment, the first panel 105 can be float glass or a borosilicate glass and have a thickness in a range of 2 mm to 20 mm thick. The first panel 105 can be a heat-treated, heat-strengthened, or tempered panel. In one embodiment, the electrochromic device 120 is coupled to the first panel 105. In another embodiment, the electrochromic device 120 is on a substrate 125 and the substrate 125 is coupled to the first panel 105. In one embodiment, a lamination interlayer 130 may be disposed between the first panel 105 and the electrochromic device 120. In one embodiment, the lamination interlayer 130 may be disposed between the first panel 105 and the substrate 125 containing the electrochromic device 120. The electrochromic device 120 may be on a first side 121 of the substrate 125 and the lamination interlayer 130 may be coupled to a second side 122 of the substrate 125. The first side 121 may be parallel to and opposite from the second side 122.

The second panel 110 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 110 can be float glass or a borosilicate glass and have a thickness in a range of 5 mm to 30 mm thick. The second panel 110 can be a heat-treated, heat-strengthened, or tempered panel. In one embodiment, the spacer 115 can be between the first panel 105 and the second panel 110. In another embodiment, the spacer 115 is between the substrate 125 and the second panel 110. In yet another embodiment, the spacer 115 is between the electrochromic device 120 and the second panel 110.

In another embodiment, the insulated glazing unit 100 can further include additional layers. The insulated glazing unit 100 can include the first panel 105, the electrochromic device 120 coupled to the first panel 105, the second panel 110, the spacer 115 between the first panel 105 and second panel 110, a third panel, and a second spacer (not shown) between the first panel 105 and the second panel 110. In one embodiment, the electrochromic device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochromic device and the third panel. A second spacer may be between the third panel and the second panel. In such an embodiment, the third panel is between the first spacer and second spacer. In other words, the third panel is coupled to the first spacer on a first side and coupled to the second spacer on a second side opposite the first side.

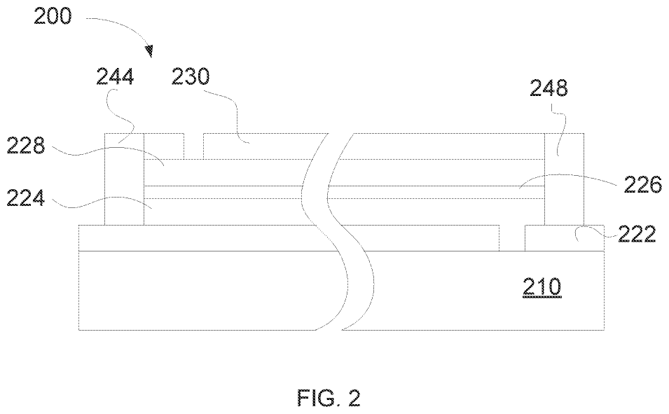

The insulated glazing unit can include a wide variety of different types of non-light-emitting variable transmission devices, as described in more detail with respect to FIG. 2. The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

The description with respect to FIG. 2 provides exemplary embodiments of a glazing that includes a glass substrate and a non-light-emitting variable transmission device disposed thereon. The embodiment as described with respect to FIG. 2 is not meant to limit the scope of the concepts as described herein. For purposes of illustrative clarity, the non-light-emitting variable transmission device 200 can be an electrochromic device. In the description below, a non-light-emitting variable transmission device will be described as normally operating with voltages on bus bars being in a range of 0 V to 3 V. Such description is used to simplify concepts as described herein. Other voltage may be used with the non-light-emitting variable transmission device or if the composition or thicknesses of layers within an electrochromic stack are changed. The voltages on bus bars may both be positive (1 V to 4 V), both negative (−5 V to −2 V), or a combination of negative and positive voltages (−1 V to 2 V), as it is the voltage difference between bus bars which is important; i.e. the voltages between the bus bars are more important than the raw numbers of the voltages with respect to ground. Furthermore, the voltage difference between the bus bars may be less than or greater than 3 V, depending on the size of the insulated glazing unit. After reading this specification, skilled artisans will be able to determine voltage differences for different operating modes to meet the needs or desires for a particular application. The embodiments are exemplary and not intended to limit the scope of the appended claims.

In accordance with the present disclosure, FIG. 2 illustrates a cross-section view of a partially fabricated electroactive device 200 having an improved film structure. For purposes of illustrative clarity, the electroactive device 200 can be a variable transmission electrochromic device. In another embodiment, the electroactive device 200 can be a thin-film battery. In yet another embodiment, the electroactive device 200 can be a liquid crystal device. In another embodiment, the electroactive device 200 can be an organic light emitting diode device or light emitting diode device. In another embodiment, the electroactive device 200 can be a dichroic device. However, it will be recognized that the present disclosure is similarly applicable to other types of scribed electroactive devices, electrochemical devices, as well as other electrochromic devices with different stacks or film structures (e.g., additional layers). The electroactive devices can be laminates or can be part of an insulated glazing unit, as described below.

With regard to the electroactive device 200 of FIG. 2, the device 200 may include a substrate 210 and a stack overlying the substrate 210. The stack may include a first transparent conductor layer 222, a cathodic electrochemical layer 224, an anodic electrochemical layer 228, and a second transparent conductor layer 230. In one embodiment, the cathodic electrochemical layer can also be referred to as an electrochromic layer. In one embodiment, the anodic electrochemical layer can also be referred to as counter electrode layer. In one embodiment, the stack may also include an ion conducting layer 226 between the cathodic electrochemical layer 224 and the anodic electrochemical layer 228.

In an embodiment, the substrate 210 can include a glass substrate, a sapphire substrate, an aluminum oxynitride substrate, or a spinel substrate. In another embodiment, the substrate 210 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 210 may or may not be flexible. In a particular embodiment, the substrate 210 can be float glass or a borosilicate glass and have a thickness in a range of 0.5 mm to 12 mm thick. The substrate 210 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 210 can include ultra-thin glass that is a mineral glass having a thickness in a range of 50 microns to 300 microns. In a particular embodiment, the substrate 210 may be used for many different electrochemical devices being formed and may be referred to as a motherboard.

Transparent conductive layers 222 and 230 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 222 and 230 can include gold, silver, copper, nickel, aluminum, or any combination thereof. The transparent conductive layers 222 and 230 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 222 and 230 can have a thickness between 10 nm and 600 nm. In one embodiment, the transparent conductive layers 222 and 230 can have a thickness between 200 nm and 500 nm. In one embodiment, the transparent conductive layers 222 and 230 can have a thickness between 320 nm and 460 nm. In one embodiment the first transparent conductive layer 222 can have a thickness between 10 nm and 600 nm. In one embodiment, the second transparent conductive layer 230 can have a thickness between 80 nm and 600 nm.

The layers 224 and 228 can be electrode layers, wherein one of the layers may be a cathodic electrochemical layer, and the other of the layers may be an anodic electrochromic layer (also referred to as a counter electrode layer). In one embodiment, the cathodic electrochemical layer 224 is an electrochromic layer. The cathodic electrochemical layer 224 can include an inorganic metal oxide material, such as WO₃, V₂O₅, MoO₃, Nb₂O₅, TiO₂, CuO, Ni₂O₃, NiO, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 224 can have a thickness between 100 nm to 400 nm. In one embodiment, the cathodic electrochemical layer 224 can have a thickness between 350 nm to 390 nm. The cathodic electrochemical layer 224 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 228 can include any of the materials listed with respect to the cathodic electrochromic layer 224 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 228 can have a thickness between 150 nm to 300 nm. In one embodiment, the anodic electrochromic layer 228 can have a thickness between 250 nm to 290 nm. In some embodiments, lithium may be inserted into at least one of the first electrode 230 or second electrode 240.

In another embodiment, the device 200 may include a plurality of layers between the substrate 210 and the first transparent conductive layer 222. In one embodiment, an antireflection layer can be between the substrate 210 and the first transparent conductive layer 222. The antireflection layer can include SiO₂, NbO₂, Nb₂O₅ and can be a thickness between 20 nm to 100 nm. The device 200 may include at least two bus bars with one bus bar 244 electrically connected to the first transparent conductive layer 222 and the second bus bar 248 electrically connected to the second transparent conductive layer 230.

Any of the electrochromic devices can be subsequently processed as a part of an insulated glass unit or laminate device, as seen in FIG. 1 The IGU can be installed as part of architectural glass along a wall of a building or a skylight, or within a vehicle. As the number and complexity of transmission of EC devices for a controlled space increases, the complexity in controlling the EC devices can also increase. Even further complexity can occur when the control of the EC devices is integrated with other building environmental controls. In an embodiment, the window can be a skylight that may include over 900 EC devices. Coordinating control of such a large number of EC devices with other environmental controls can lead to very complicated control schemes, which some facilities personnel without extensive computer programming and experience with complex control systems may find very challenging. Design of a power distribution network can depend on many factors including, but not limited to, the number of windows installed, the power consumption due to wire resistance, the location of installed windows, the location of building power sources/control panels/other power sources, the layout of windows being installed, the existing infrastructure where windows are being installed, etc. As the need for power increases, so too does the limitation on the circuit distribution network.

Accordingly, a simplified control algorithm and control panel can be used during commissioning of an electrochromic device in order to detect faults in the installation and wiring or any defects in the electrochromic panel itself before full installation is complete. Doing so can help alleviate the time and cost of installing a faulty device or fixing a damaged cable. Additionally, a temporary control device can aid in diagnosing a problem by measuring the voltages and currents running across any electrochromic device to see if an open circuit exists or to test the transmission levels of the electrochromic devices.

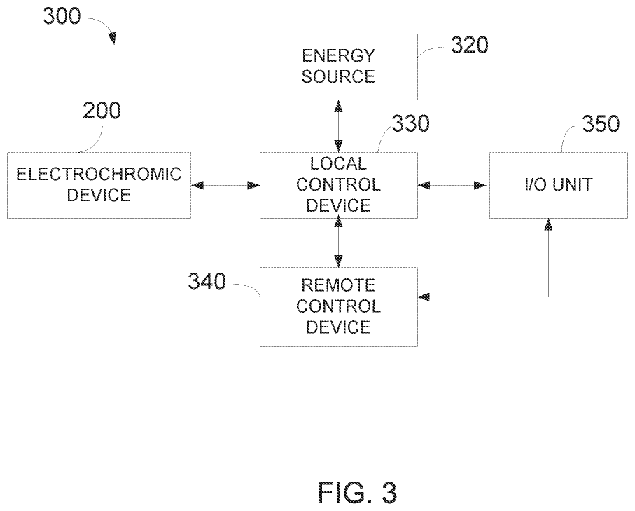

FIG. 3 includes a simplified schematic diagram of an apparatus 300 that includes the EC device 200, an energy source 320, a local control device 330, a remote control device 340, and an input/output (I/O) unit 350. The energy source 320 provides energy to the EC device 200 via the local control device 330. In an embodiment, the energy source 320 may include a photovoltaic cell, an AC power source, a battery, another suitable energy source, or any combination thereof.

The local control device 330 can be coupled to the EC device 200, the energy source 320, the remote control device 340, and the I/O unit 350. The local control device 330 can include logic to control the operation of the EC device 200 and will be described in more detail later in this specification. In an embodiment, the remote control device 340 can include logic to control the operation of building environmental and facility controls, such as heating, ventilation, and air conditioning (HVAC), lights, scenes for EC devices, including the EC device 200, and will be described in more detail later in this specification. In an embodiment, the local control device 330 may be within a controlled space having the EC device, and the remote control device 340 may be outside the controlled space having the EC device. The controlled space may be a room, such as a meeting room or an office, or may be part of a floor of a building, wherein a window of the EC device can affect light, glare, or temperature of the controlled space. The logic for either or both of control devices 330 and 340 can be in the form of hardware, software, or firmware. In an embodiment, the logic may be stored in a field programmable gate array (FPGA), an application-specific integrated circuit (ASIC), a hard drive, a solid state drive, or another persistent memory. In an embodiment, the control devices 330 and 340 may include a processor that can execute instructions stored in memory within the control devices 330 and 340 or received from an external source.

More or fewer control devices may be used. In an embodiment, all of the functions that will be described with respect to the remote control device 340 may be incorporated into the local control device 330. In another embodiment, more than one local control device may be used. For example, a local control device may be adjacent to an IGU, and another local control device may be within the controlled space and spaced apart from the IGU. Such other local control devices may be near light switches, a thermostat, or a door for the controlled space. Logic operations are described below with respect to particular control devices with respect to an embodiment. In another embodiment, a logic operation described with respect to a particular control device may be performed by another control device or be split between the control devices. After reading this specification, skilled artisans will be able to determine a particular configuration that meets the needs or desires for a particular application.

The I/O unit 350 can be coupled to the control devices 330 and 340 or just one of the control devices. In another embodiment, the I/O unit 350 can include a monitor and keyboard for a human to interact with the apparatus 300. With respect to the EC device 200, the location of the other components in the apparatus 300 may be adjacent to or spaced apart from the EC device 200. In an embodiment, the IGU 100 in FIG. 1 may include the EC device 200 and the energy source 320. In another embodiment, the energy source 320, the local control device 330, the I/O unit 350 may be located in or attached to a frame that holds the IGU 100. In a further embodiment, the local control device 330, the remote control device 350, the I/O unit 350, or any combination thereof may be located over a meter from the IGU 100 and frame. After reading this specification, skilled artisans will be able to determine the particular location of components of the apparatus 300 for a particular application.

The control link can be a wireless connection. In an embodiment, the control link can use a wireless local area network connection operating according to one or more of the standards within the IEEE 802.11 (Wi-Fi) family of standards, low-power wide-area networks (LPWANs), cell networks, and low-earth orbit (LEO) satellite networks. In one embodiment, a receiver may be located adjacent the IGU. In a particular embodiment, the wireless connections can operate within the 2.4 GHz ISM radio band, within the 5.0 GHz ISM radio band, or a combination thereof. In one embodiment, the electronics module can be electrically connected to controllers via a plurality of sets of frame cables. Each electrochromic device can be connected to its corresponding controller via its own frame cable. The building management system can include logic to control the operation of building environmental and facility controls, such as heating, ventilation, and air conditioning (HVAC), lights, scenes for EC devices, including the EC device 200. The logic for the building management systems can be in the form of hardware, software, or firmware. In an embodiment, the logic may be stored in a field programmable gate array (FPGA), an application-specific integrated circuit (ASIC), a hard drive, a solid state drive, or another persistent memory. In an embodiment, the building management system may include a processor that can execute instructions stored in memory within the building management system or received from an external source.

The control devices 330 and 340 can best be understood in combination with the method 400 of controlling the electrochromic device of FIG. 2. In one embodiment, the method 400 can begin with one or more electrochromic devices being provided. In one embodiment, the one or more electrochromic devices are being installed in a frame for the first time, such as during commissioning. In general, the one or more electrochromic devices include wiring that goes from the electrochromic device through the frame and connects to the control devices 330 and 340.

Typically, specialized equipment or software is needed to fully configure and integrate a control system before attempting to operate it. However, a simplified control system can be used initially to check for any defects within the wiring system or electrochromic device. Additionally, a simplified control system can aid in resolving any problems found within the wiring system or electrochromic device. Accordingly, the method 400 can include connecting a control device to the one or more electrochromic devices, at operation 410. In one embodiment, the control device is a temporary commissioning control device that will be replaced by a permanent control device before the electrochromic device is in normal operation. In one embodiment, the control device is configured to set a voltage for each electrochromic device to at most 2.0V. In another embodiment, the control device is configured to set a voltage for each electrochromic device to a voltage known to be safe for all product sizes and configurations. In one embodiment, the control device is configured to set a voltage for each electrochromic device to at least 0.5V. Voltages for controlling electrochromic devices can be determined in part by the size and shape of the electrochromic panel. A larger panel might require more current to flow between the bus bars in order to effectuate a fast and homogenous switching from a fully clear transmission state to a fully graded transmission state. If too high of a voltage is used, the electrochromic panel could be damaged and cease operating. In part, the complexity of commissioning is determining the appropriate voltage per panel within a façade taking into account the size of the panel and the resistance across the wiring. However, since the commissioning controllers set the voltage for each electrochromic device at an amount that is lower than the normal operating voltage, regardless of the size of the panel, the current will not be too much for any one device. On the other hand, since the voltage is so low, fully tinting from a clear transmission state to a fully tinted transmission state may take a longer amount of time than during normal operation of the electrochromic devices. This is purposefully done to check the devices for any defects without having to know the exact voltage limitations of each device. The controllers can set the commissioning voltage to less than 2.0 V for a period of between 30 minutes and 48 hours. In one embodiment, the controllers can set the commissioning voltage to less than 2.0V for a period of between 30 minutes and 16 hours. As such, the method 400 can continue by setting a voltage for the one or more electrochromic devices to a commissioning voltage, at operation 420. The commissioning voltage can be between 0.5 V and 2.0 V.

The control device can further include a component that is configured to reduce a voltage of power received over a power input port to voltages of power transmitted over the controller port to the individual electrochromic devices. The component can include a transformer or a voltage regulator. In one embodiment, the commissioning voltage is less than the normal operational voltage. In one embodiment, the controller can include a BACnet interface. In another embodiment, the controller can include an integrated Ethernet switch and/or wireless interface. In another embodiment, the controller can include an SSL chip configured to encrypt communication between the controllers and control device, such as a mobile phone, laptop computer, pc, or other external device.

A person of ordinary skill in the art will understand how to determine the normal operational voltage from the description given above. At operation 430, the commissioning voltage tints the one or more electrochromic devices from a fully clear transmission level to a fully tinted transmission level to determine if any defects exist either within the electrochromic device or within the wiring system. In one embodiment, the commissioning voltage tints the one or more electrochromic devices from a fully clear transmission level to a fully tinted transmission level to determine if any defects exist. The tint level is a percentage of light transmission through the electrochromic device, such as full tint (e.g., 1% transmission level), full clear (e.g., 63%+/−10% transmission level), or graded transmission.

The method can further include fixing any defects in the wiring system, such as open circuits or bad connections, fixing the defects detected in the one or more electrochromic devices, or replacing a defective electrochromic device. Once all of the cables and one or more electrochromic devices have been determined to be clear of defects or the defects repaired, a different control device can be installed that is configured to provide a normal operating voltage for the installed fully functioning electrochromic devices. In one embodiment, the control device can be physically changed. In another embodiment, the control device can be the same but a new set of instructions installed into the control device for controlling the one or more electrochromic devices at a normal operating procedure. In other words, for commissioning, the control device could have a first set of instructions limiting the amount of voltage to the one or more electrochromic devices to be less than 2.0 V and then a second set of instructions allowing for a voltage above 2.0 V, such as between 0 V and 25 V. In one embodiment, during normal operations, the controller can set a voltage that is at most 12 V, at most 6 V, or at most 3 V for the one or more electrochromic devices. In one embodiment, a logic element, such as a processor, e.g., may be included to perform the method steps described above.

The power and the control signals for the controller can be configured to be transmitted over different conductors within a first cable. Specifically, the power can be transmitted over a first twisted pair of conductors of a cable, and the control signals can be transmitted over a second twisted pair of conductors of the same cable. Alternatively, at least part of the power and at least part of the control signals for a controller are transmitted over a same conductor of a cable.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A method of testing one or more electrochromic devices during commissioning is disclosed. The method can include providing one or more electrochromic devices, and at least one controller, where the controller is electrically connected to the one or more electrochromic devices; setting a commissioning voltage for the one or more electrochromic devices, where the commissioning voltage is no more than 2 V; and sending the commissioning voltage to each of the one or more electrochromic devices to change the one or more electrochromic devices from a first transmission state to a second transmission state, where the at least one controller sends the commissioning voltage.

Embodiment 2. The method of embodiment 1, where the one or more electrochromic devices are of varying shapes and sizes.

Embodiment 3. The method of embodiment 1, further can include setting the at least one controller to a commissioning mode, where the controller in the commissioning mode is configured to provide a voltage of no more than 2 V to the one or more electrochromic devices.

Embodiment 4. The method of embodiment 3, further can include maintaining the commissioning voltage for between 30 minutes and 48 hours.

Embodiment 5. The method of embodiment 1, further can include determining if any defects exist in the one or more electrochromic devices or wiring.

Embodiment 6. The method of embodiment 5, where the commissioning voltage is configured to determine if any defects exist in the one or more electrochromic devices.

Embodiment 7. The method of embodiment 6, further can include changing the at least one controller to a normal operating controller configured to provide a voltage between 0 V and 24 V to the one or more electrochromic devices.

Embodiment 8. The method of embodiment 6, further can include changing the programming of the at least one controller to a normal operation mode, where the at least one controller in the normal operation mode is configured to provide a voltage between 0V and 24V to the one or more electrochromic devices.

Embodiment 9. The method of embodiment 1, where the first transmission state is full clear and the second transmission state is a fully tinted transmission state.

Embodiment 10. The method of embodiment 1, where the first transmission state is full clear and the second transmission state is a graded transmission state.

Embodiment 11. The method of embodiment 1, where the electrochromic device, can include: a first transparent conductive layer; a second transparent conductive layer; an electrochromic layer between the first transparent conductive layer and the a second transparent conductive layer; a counter electrode layer between the first transparent conductive layer and the a second transparent conductive layer; and an electrolyte layer between the electrochromic layer and the counter electrode layer.

Embodiment 12. The method of embodiment 11, where the electrochromic layer can include a material selected from the group consisting of WO₃, VO₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 13. The method of embodiment 11, where the substrate can include a material selected from the group consisting of glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 14. The method of embodiment 11, where the first transparent conductive layer can include a material selected from the group consisting of indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 15. The method of embodiment 11, where the second transparent conductive layer can include a material selected from the group consisting of indium oxide, indium tin oxide, doped indium oxide, tin oxide, doped tin oxide, zinc oxide, doped zinc oxide, ruthenium oxide, doped ruthenium oxide and any combination thereof.

Embodiment 16. The method of embodiment 11, where the anodic electrochromic layer can include an inorganic metal oxide electrochromicly active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Embodiment 17. A system for testing one or more electrochromic devices during commissioning, can include: one or more electrochromic devices; and one or more commissioning controllers, where the one or more commissioning controllers are configured to provide at most 2 V to the one or more electrochromic devices.

Embodiment 18. The system for testing one or more electrochromic devices during commissioning of embodiment 17, further can include one or more normal operating controllers, where the one or more operating controllers are configured to provide a voltage between 0V and 24V to the one or more electrochromic devices.

Embodiment 19. The system for testing one or more electrochromic devices during commissioning of embodiment 17, where the one or more commissioning controllers is configured to detect an error in the system before normal operation of the system.

Embodiment 20. A non-transitory computer readable medium containing a program of instructions for testing one or more electrochromic devices during commissioning and controlling the one or more electrochromic devices, execution of which by a processor causes the steps of: setting at least one controller to a commissioning mode, where the controller in the commissioning mode is configured to provide a voltage of no more than 2 V to the one or more electrochromic devices; and sending the commissioning voltage to each of the one or more electrochromic devices to change the one or more electrochromic devices from a first transmission state to a second transmission state, where the at least one controller sends the commissioning voltage.

Note that not all of the activities described above in the general description, or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the embodiments.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of testing one or more electrochromic devices and/or wiring during commissioning, comprising:
providing one or more electrochromic devices, and at least one controller, wherein the controller is electrically connected to the one or more electrochromic devices;
setting a commissioning voltage for the one or more electrochromic devices, wherein the commissioning voltage is no more than 2 V; and
sending the commissioning voltage to each of the one or more electrochromic devices to change the one or more electrochromic devices from a first transmission state to a second transmission state, wherein the at least one controller sends the commissioning voltage.

2. The method of claim 1, wherein the one or more electrochromic devices are varying shapes and sizes.

3. The method of claim 1, further comprising setting the at least one controller to a commissioning mode, wherein the controller in the commissioning mode is configured to provide a voltage of no more than 2 V to the one or more electrochromic devices.

4. The method of claim 3, further comprising maintaining the commissioning voltage for between 30 minutes and 48 hours.

5. The method of claim 1, further comprising determining if any defects exist in the one or more electrochromic devices or wiring.

6. The method of claim 5, wherein the commissioning voltage is configured to determine if any defects exist in the one or more electrochromic devices.

7. The method of claim 6, further comprising changing the at least one controller to a normal operating controller configured to provide a voltage between 0 V and 24 V to the one or more electrochromic devices.

8. The method of claim 6, further comprising changing the programming of the at least one controller to a normal operation mode, wherein the at least one controller in the normal operation mode is configured to provide a voltage between 0V and 24V to the one or more electrochromic devices.

9. The method of claim 1, wherein the first transmission state is full clear and the second transmission state is a fully tinted transmission state.

10. The method of claim 1, wherein the first transmission state is full clear and the second transmission state is a graded transmission state.

11. The method of claim 1, wherein the electrochromic device, comprises:
a first transparent conductive layer;
a second transparent conductive layer;
an electrochromic layer between the first transparent conductive layer and the a second transparent conductive layer;
a counter electrode layer between the first transparent conductive layer and the a second transparent conductive layer; and
an electrolyte layer between the electrochromic layer and the counter electrode layer.

12. The method of claim 11, wherein the electrochromic layer comprises a material selected from the group consisting of WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

13. The method of claim 11, wherein the substrate comprises a material selected from the group consisting of glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

14. The method of claim 11, wherein the first transparent conductive layer comprises a material selected from the group consisting of indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

15. The method of claim 11, wherein the second transparent conductive layer comprises a material selected from the group consisting of indium oxide, indium tin oxide, doped indium oxide, tin oxide, doped tin oxide, zinc oxide, doped zinc oxide, ruthenium oxide, doped ruthenium oxide and any combination thereof.

16. The method of claim 11, wherein the anodic electrochromic layer comprises an inorganic metal oxide electrochromicly active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

17. A system for testing one or more electrochromic devices and/or wiring during commissioning, comprising:
one or more electrochromic devices; and
one or more commissioning controllers, wherein the one or more commissioning controllers are configured to provide at most 2 V to the one or more electrochromic devices.

18. The system for testing one or more electrochromic devices during commissioning of claim 17, further comprising one or more normal operating controllers, wherein the one or more operating controllers are configured to provide a voltage between 0V and 24V to the one or more electrochromic devices.

19. The system for testing one or more electrochromic devices during commissioning of claim 17, wherein the one or more commissioning controllers is configured to detect an error in the system before normal operation of the system.

20. A non-transitory computer readable medium containing a program of instructions for testing one or more electrochromic devices and/or wiring during commissioning and controlling the one or more electrochromic devices, execution of which by a processor causes the steps of:
setting at least one controller to a commissioning mode, wherein the controller in the commissioning mode is configured to provide a voltage of no more than 2 V to the one or more electrochromic devices;
sending the commissioning voltage to each of the one or more electrochromic devices to change the one or more electrochromic devices from a first transmission state to a second transmission state, wherein the at least one controller sends the commissioning voltage.
